(19) United States
(12) Patent Application Publication
(10) Pub. No.: US 2026/0131342 A1
(43) Pub. Date: May 14, 2026

(54) DEVICE FOR DISPENSING A FLUID SUBSTANCE

(71) Applicant: LUMSON S.p.A., CAPERGNANICA (CR) (IT)

(72) Inventor: Matteo MORETTI, Crema (CR) (IT)

(21) Appl. No.: 19/384,133

(22) Filed: Nov. 10, 2025

(30) Foreign Application Priority Data
Nov. 11, 2024 (IT) 102024000025344

(51) Int. Cl. B05B 11/10; B05B 11/00

(52) U.S. Cl. CPC B05B 11/1047; B05B 11/0038

(57) ABSTRACT

A device (1) for dispensing a fluid substance comprising an outer container (2) and a deformable bag (4), the deformable bag being housed in the outer container (2) and endowed with a neck (7) from which a first flange (6) extends, a pump (3) coupled to the deformable bag (4) in a sealed manner, and a ring element (5), which rests on a free edge (8) of the outer container (2) and is endowed with an opening (9) configured to at least partially house the neck (7) of the deformable bag (4), the opening (9) being peripherally delimited by a support surface (10) that comes into contact with the said first flange (6) on the deformable bag (4), supporting the said bag, the ring (5) being made of at least two half-shells (5A, 5B) configured to close around the neck of the deformable bag (4).

This application claims the benefit of Italian Patent Application for Invention No. 102024000025344 filed on November 11, 2024, the disclosure of which is incorporated herein by reference.

### FIELD OF THE INVENTION

The present invention relates to a device for dispensing a fluid substance.

In particular, it refers to a manually operated dispensing device wherein the fluid substance is housed inside a deformable bag. Advantageously, the said device features a refill system.

### BACKGROUND ART

Dispensing devices for a fluid substance are commonly known in which the fluid is housed inside a deformable bag (fitted inside an outer container, which is usually made of glass and is therefore very high quality).

The deformable bag is coupled to a pump (preferably of the airless variety) for dispensing the fluid substance.

In an industrial context, during production of the device, the deformable bag is rather delicate and must be handled with care before being fitted into the outer container, which protects the said bag.

Fitting the deformable bag into the outer container is often a rather critical moment and can cause damage to the said deformable bag, resulting in waste.

### SUMMARY OF THE INVENTION

The object of the present invention is to provide a device for dispensing a fluid substance which is improved compared with the prior art.

A further object of the invention is to provide a device for dispensing a fluid substance that makes it easier to fit the deformable bag into the outer container.

A still further other object of the invention is to minimise potential damage to the deformable bag that could occur during coupling to/fitting into the outer container.

This and other objects are achieved by means of a device for dispensing a fluid substance produced according to the technical teachings of the appended claims.

### BRIEF DESCRIPTION OF THE FIGURES

Further features and advantages of the innovation will become clearer in the description of a preferred but not exclusive embodiment of the device, illustrated - by way of a non-limiting example - in the drawings appended hereto, in which:

FIG. 1 is a simplified axial sectional view of a device according to the invention, in which the outer container is a jar;

FIG. 2 is an exploded perspective view of some parts of the device in FIG. 1;

FIGS. 3, 4, and 5 are perspective views of some possible embodiments of a part of the device in FIG. 1;

FIG. 6 is a simplified axial sectional view of the device according to the present invention, in which the outer container is a bottle; and

FIGS. 7 and 8 are possible configurations of a part of the device in FIG. 6 coupled to a deformable bag specific to the device in FIG. 6.

### DETAILED DESCRIPTION OF THE INVENTION

With reference to the figures stated, reference number 1 is used to denote, as a whole, a device for dispensing a fluid substance.

In this context, a fluid substance may be understood to mean a cream (whether cosmetic or medical), such as a dispensable fluid product for personal care, makeup, deodorant, soap, tanning cream or sunscreen, etc.

The fluid substance dispensing device 1 comprises an outer container 2 formed in a single piece. The outer container is preferably made of glass, which may be decorated in various ways.

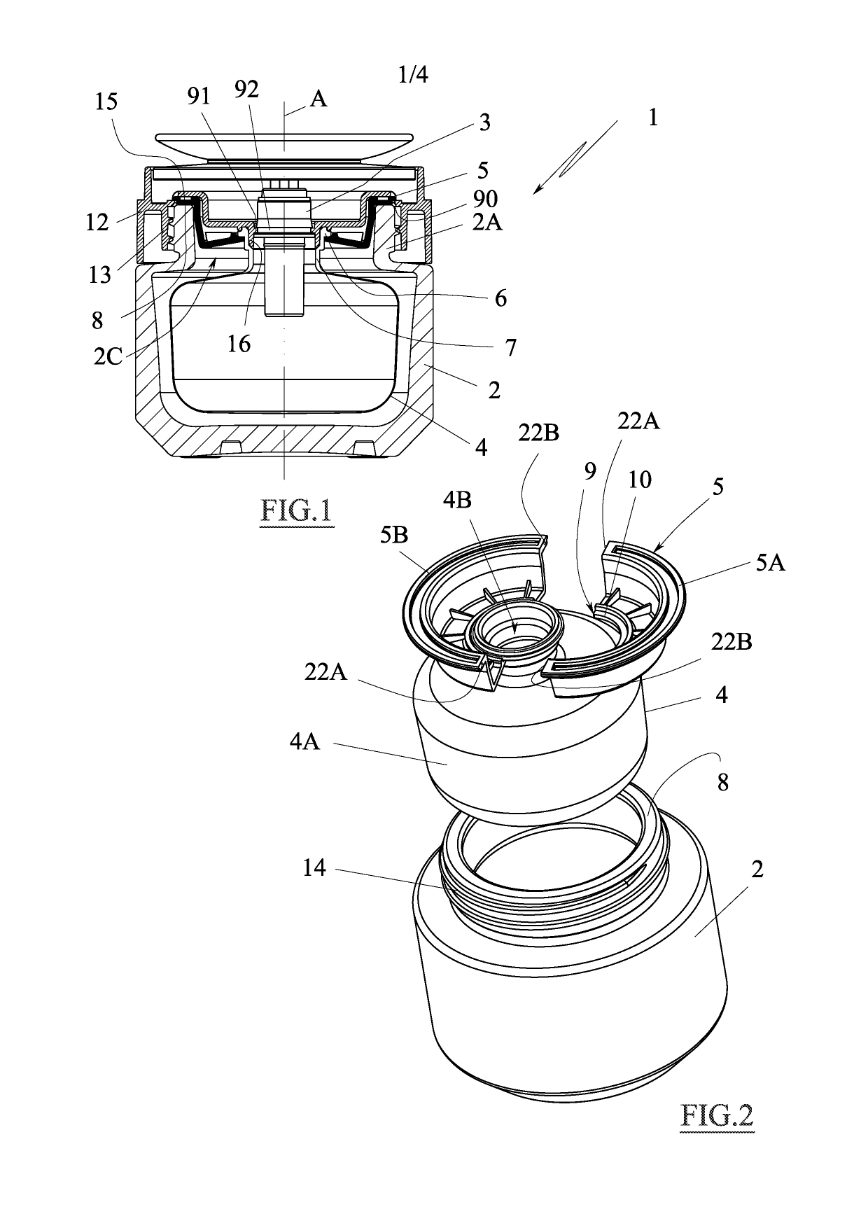

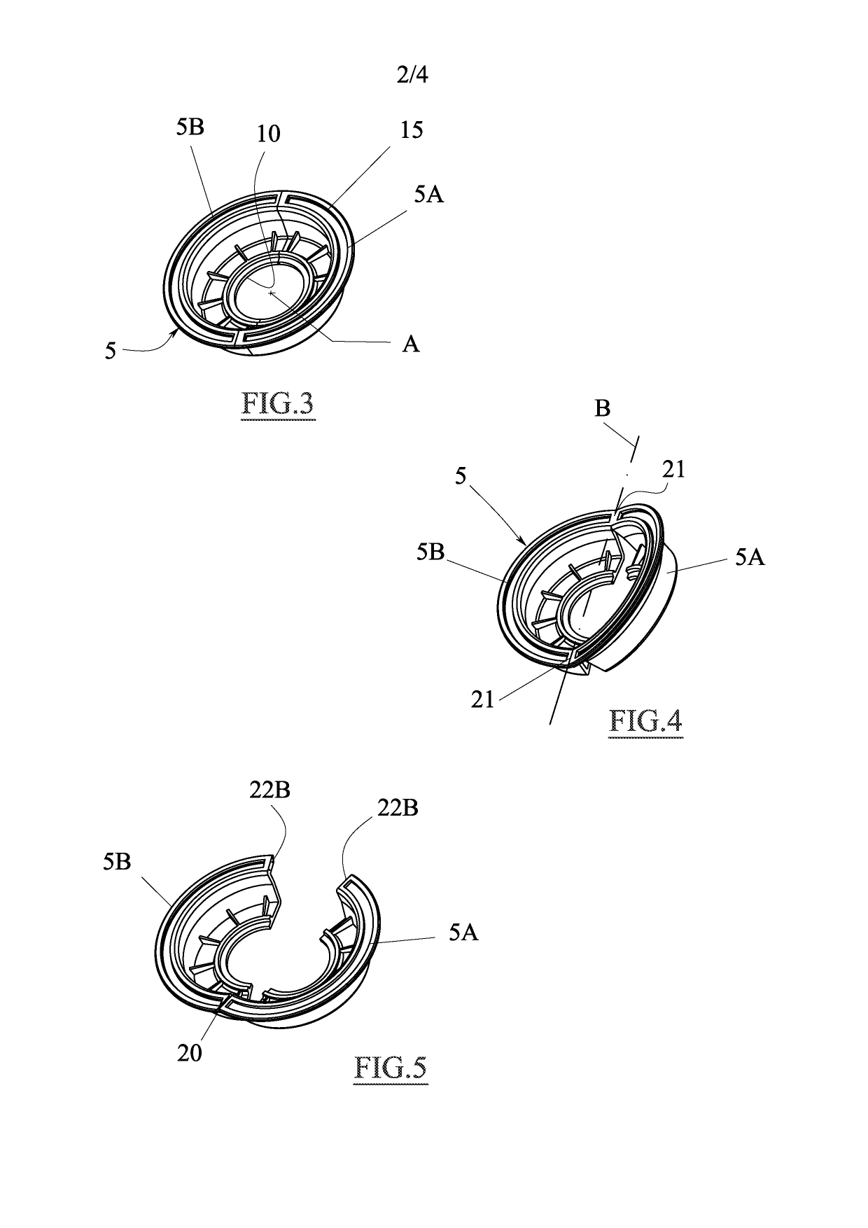

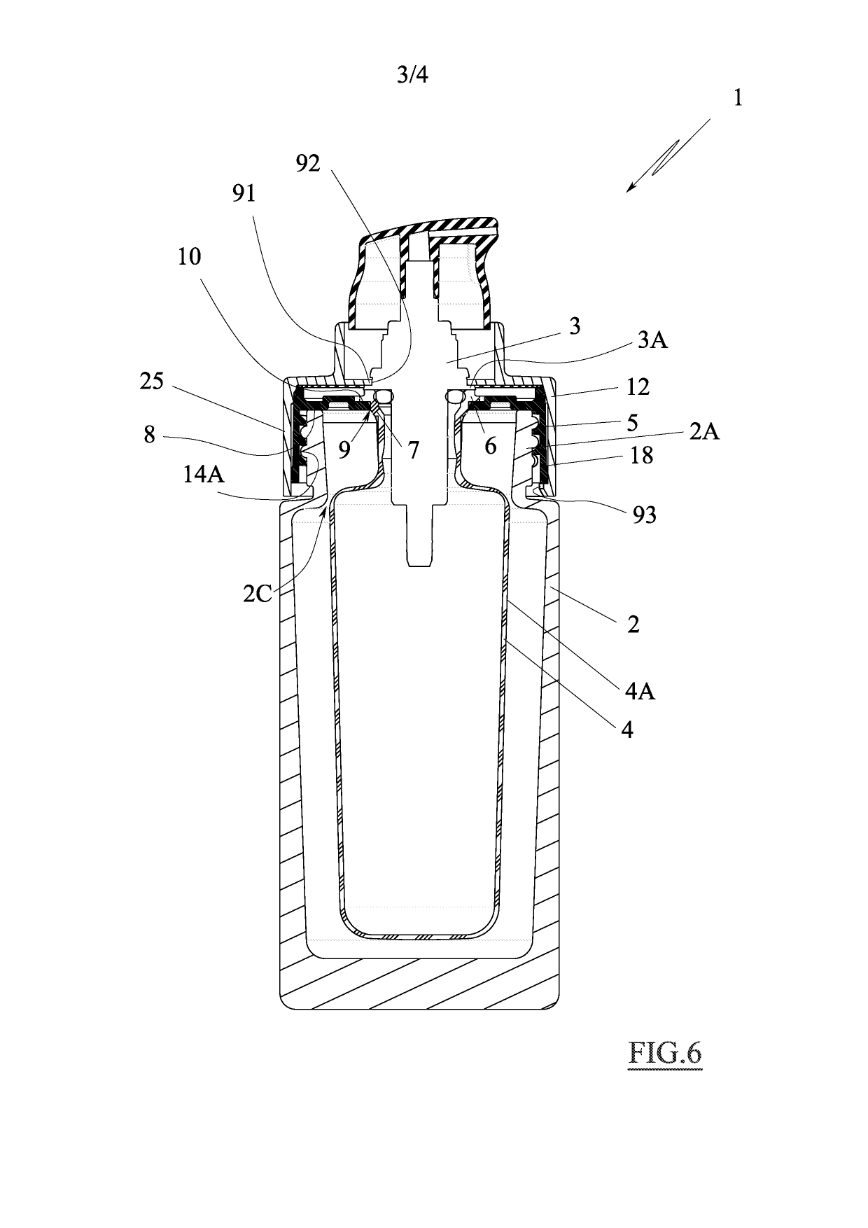

In the configuration in FIG. 1, the outer container is a jar, while in the configuration in FIG. 6, the outer container is a bottle.

In both cases, the outer container houses a deformable bag 4 which contains the fluid.

The deformable bag 4 can be made using a single- or multi-layer extrusion and blow-moulding process. Alternatively, the said bag can be made by making an injection or bi-injection preform which is then blow-moulded to form a pouch prior to use.

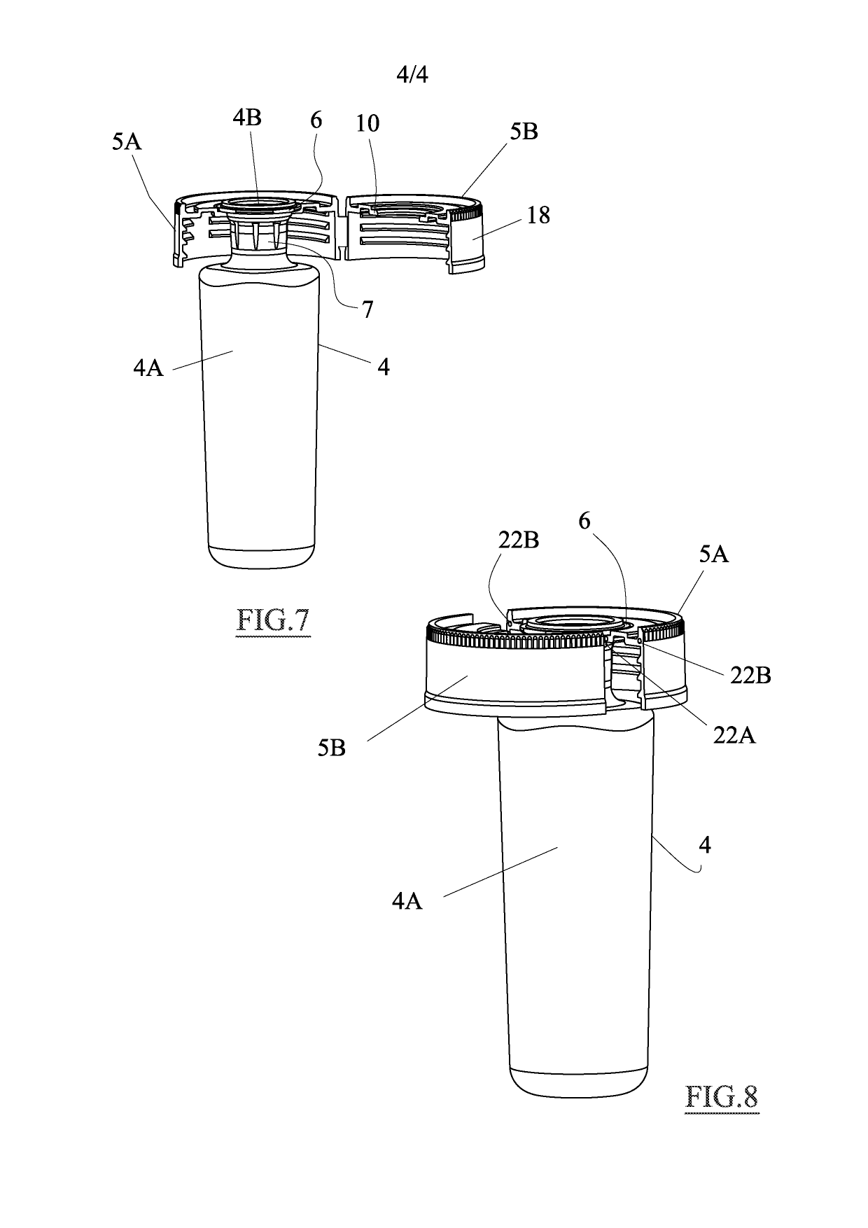

As can be seen in FIG. 2 and also in FIG. 7, the deformable bag may have a wider part 4A (which is intended to contain the fluid) from which a neck 7 extends, which is narrower than the wider part. A (possibly discontinuous) flange 6, may extend from the neck 7, for example, near an opening 4B in the deformable bag.

A pump 3, coupled to the deformable bag 4 in a sealed manner, may be positioned in the opening 4B. The pump may be atmospheric, but it is preferably airless.

According to the invention, a ring element 5 is envisaged, which rests on a free edge 8 of the outer container 2 and is endowed with an opening 9 configured to at least partially accommodate the

neck 7 of the deformable bag 4. In practice, the ring element 5, when coupled to the deformable bag, surrounds the neck 7 thereof.

The free edge 8 of the outer container 2 may be defined on a container neck 2A having a container opening 2C.

The opening 9 is perimetrically delimited by a support surface 10, which may also be discontinuous and comes into contact with the first flange 6 on the deformable bag 4, supporting the latter.

As can be seen in both FIG. 2 and FIG. 7, the ring 5 is made of at least two half-shells 5A, 5B, which are configured to close around the neck 7 of the deformable bag 4.

This eliminates the prior-art need to crush the deformable bag (and in particular the wider part 4A) to allow the bag to fit through the opening 9 in the ring 5 so at to fit the ring 5 onto the neck.

It is sufficient to join the half-shells 5A and 5B that form the ring 5 around the neck 7, thereby preventing any deformation or crushing of the deformable bag 4.

It is evident that the operation to couple the ring 5 to the neck 7 of the deformable bag 4 can also, hypothetically, take place when the bag 4 is full of fluid, which cannot be done with conventional systems which are commonly known prior to this invention.

The container opening 2C may be wide enough to allow the bag 4, possibly even when full of product (fluid substance), to be fitted inside the outer container 2 without substantial deformation of the wider part 4A of the bag 4, as it can be seen in FIG. 1. Only a slight or minimal deformation of the wider part 4A is required to fit even a full bag 4 inside the outer container 2.

The widest part of the wider part 4A of the bag 4 can be smaller than narrower part of the container opening 2C, as seen in FIG. 6. In this case the bag 4 can be fitted inside the outer container 2, without deforming it.

Advantageously, the ring element 5 is snap-fitted onto a ring nut 12 that secures the pump 3, which - when removed from the outer container 2 - takes the ring element 5 and the deformable bag 4 with it.

In the configuration shown in FIG. 1, the ring nut 12 may include a first threaded skirt 13. The thread on the threaded skirt mates with a first counter thread 14, or mating thread, on the outer container 2.

The ring element 5 may form a second flange 15, which rests on the free edge 8, sandwiched between the said free edge 8 of the outer container 2 and the said ring nut 12.

Note that, when the second flange 15 is resting on the free edge 8, a portion of the ring 5 is fitted inside the mouth of the outer container, and therefore the two half-shells 5A, 5B that form the ring element cannot be separated and therefore remain extremely stable.

In this configuration, the second flange 15, and in particular at least a portion of the outer perimeter thereof, can snap-fit to engage with at least one corresponding tooth 90 on the ring nut 12.

Furthermore, the first flange 6 of the deformable bag 2 can be sandwiched between the ring element 5 and the ring nut 12.

For example, the ring nut 12 can form a sealing lip 16 that fits into the neck 7 of the deformable bag.

Furthermore, the system can also form a seal between the pump body and the first flange 6.

Optionally, and this applies to both the configuration described above and the one shown in FIG. 6, the ring nut 12 can be snap-fitted onto the pump 3.

For this purpose, the pump 3 can feature a groove 92 with which a special protrusion 91 on the ring nut 12 engages, possibly in a sealed manner.

As shown in FIG. 6, for example, the ring element 5 forms a second threaded skirt 18 that cooperates with a second mating thread 14A on the outer container 2.

It is obvious that since the ring element 5 is formed of two shells 5A, 5B, the said element cannot ensure effective cooperation between the threaded skirt 18 and the mating thread 14A. When screwed on, the said element would open.

To make the coupling effective, the ring nut 12 can form a third skirt 25 which, when the ring nut 12 is mounted onto the ring element 5, surrounds the second skirt 18 so as to stabilise the coupling between the half-shells 5A, 5B, thereby preventing the said half-shells from opening or, in any case, from moving away from each other.

Advantageously, in this case, the ring nut 12 can be snap-fitted onto the ring 5 via at least one appropriate tooth 93 featured on a free edge of the third skirt 25 (on the ring nut 12), which interacts with a free edge of the second skirt 18 (on the ring element 5).

In this configuration, a sealing element (for example, the O-ring shown in FIG. 6) can be envisaged between the pump 3 and the deformable bag 4.

Finally, FIG. 6 shows that the pump 3 can feature a third flange 3A resting on the first flange 6 on the deformable bag, the said flanges being sandwiched between the ring nut 12 and the ring element 5.

More specifically, the third flange 3A and the first flange 6 can be sandwiched between the support surface 10 and the protrusion 91.

Possible configurations of the device have been discussed above, but the half-shells 5A and 5B can also have different configurations to facilitate the assembly thereof on the neck 7. Such configurations are adaptable to both the device shown in FIG. 1 and that shown in FIG. 6.

For example, they can be hinged together at a single point 20 so as to rotate around an axis parallel to the axis A of the ring element 5 (as shown in FIGS. 5 and 7) or at two points 21 (FIG. 4) so as to rotate solely around an axis B (perpendicular to axis A).

Regardless of whether or not there is a hinge, or hinges, present, the half-shells can feature interconnection means 22A, 22B (for example, a pin 22A and a seat 22B) that allow a stable mutual connection (at least until the ring 5 engages with the ring nut 12 or with the outer container 2).

Obviously, the pin that engages (with slight friction) in the seat is only an example of a possible embodiment of the interconnection means, which may be of any type useful for ensuring a stable connection of the half-shells before they are coupled to the ring nut 12 (or to the outer container 2), which - in practice - stabilises the coupling.

Various embodiments of the innovation have been disclosed herein, but further embodiments may also be conceived using the same innovative concept.

Claims:

1. A device (1) for dispensing a fluid substance comprising an outer container (2) formed in a single piece and a deformable bag (4), the deformable bag (4) being housed in the outer container (2) and provided with a neck (7) from which extends a first flange (6) and a wider part (4A), which is intended to contain the fluid substance, from which the neck (7) extends, the neck (7) being narrower than the wider part (4A), a pump (3) associated tightly with the deformable bag (4), and a ring element (5) resting on a free edge (8) of the outer container (2) and provided with an opening (9) configured to accommodate at least partially the neck (7) of the deformable bag (4), the ring element (5) completely surrounding the neck (7), the opening (9) of the ring element (5) being perimeterally bounded by a support surface (10) that meets said first flange (6) of the deformable bag (4), supporting it, the ring (5) being made of at least two half-shells (5A, 5B) configured to close around the neck (7) of the deformable bag (4).

2. The device according to claim 1, wherein the ring element (5) is snap-fitted to a ring nut (12) securing the pump (3) which, when removed from the outer container (2), drags the ring element (5) and the deformable pouch (4) with it.

3. The device according to claim 2, wherein the ring nut (12) is snapped into the pump (3).

4. The device according to claim 2, wherein the ring nut (12) provides a first threaded skirt (13) that couples to a first counter thread (14) of the outer container (2), the ring element (5) defining a second flange (15) sandwiched between said free edge (8) of the outer container (2) and said ring nut (12).

5. The device according to claim 4, wherein the first flange (6) of the deformable bag (4) is sandwiched between said ring element (5) and said ring nut (12).

6. The device according to claim 4, wherein the ring nut (12) defines a sealing lip (16) that fits into the neck (7) of the deformable bag.

7. The device according to claim 2, wherein the ring element (5) defines a second threaded skirt (18) that cooperates with a second counter thread (14A) of the outer container (2).

8. The device according to claim 7, wherein the pump (3) provides a third flange (3A) resting on the first flange (6) of the deformable bag, said flanges being sandwiched between the ring nut (12) and the ring element (5).

9. The device according to claim 7, wherein the ring nut (12) defines a third skirt (25) which, when the ring nut (12) is mounted on the ring element (5) surrounds the second skirt (18) so as to stabilize the coupling between the half-shells (5A,5B).

10. The device according to claim 1, wherein the half-shells (5A, 5B) are hinged together at a single point (20) or at two points (21).

11. The device according to claim 1, wherein the half-shells have interconnecting means (22A, 22B) that allow their reciprocal connection.

12. The device according to claim 1, wherein the free edge (8) of the outer container (2) is defined on a container neck (2A) having a container opening (2C) wide enough to allow the bag (4) to be fitted inside the outer container (2) without substantial deformation of the wider part (4A) of the bag (4).

13. The device according to claim 12, wherein the widest part of the wider part (4A) of the bag (4) is smaller than narrower part of the container opening (2C).
